(19) United States
(12) Patent Application Publication
(10) Pub. No.: US 2015/0207565 A1
(43) Pub. Date: Jul. 23, 2015

(54) INTERFACE CIRCUIT FOR TRANSMITTING AND RECEIVING SIGNALS BETWEEN ELECTRONIC DEVICES, AND SEMICONDUCTOR MEMORY CHIP AND OPERATION PROCESSING DEVICE INCLUDING THE SAME

(71) Applicant: Electronics and Telecommunications Research Institute, Daejeon (KR)

(72) Inventors: Hyuk Je KWON, Daejeon (KR); Yongseok CHOI, Daejeon (KR); Gyungock KIM, Daejeon (KR)

(21) Appl. No.: 14/595,754

(22) Filed: Jan. 13, 2015

(30) Foreign Application Priority Data
Jan. 17, 2014 (KR) 10-2014-0005879

(51) Int. Cl. H04B 10/2575

(52) U.S. Cl. CPC H04B 10/2575

(57) ABSTRACT

An interface circuit configured to transmit and receive signals between electronic devices is provided. The interface circuit includes an optical connection protocol manager configured to serialize a parallel transmission packet electrical signal generated based on output data to generate a serialized transmission packet electrical signal, parallelize a serial reception packet electrical signal to generate a parallelized reception packet electrical signal, and parse the parallelized reception packet electrical signal according to whether there is an error in the parallelized reception packet electrical signal to generate input data; and an electro-optical converter configured to convert the serialized transmission packet electrical signal into a transmission packet optical signal to output the transmission packet optical signal, receive a reception packet optical signal, and convert the reception packet optical signal into the serial reception packet electrical signal to provide the serial reception packet electrical signal to the optical connection protocol manager.

### CROSS-REFERENCE TO RELATED APPLICATIONS

This present application claims priority to and the benefit of under 35 U.S.C. §119 Korean Patent Application No. 10-2014-0005879, filed on Jan. 17, 2014, the entire contents of which are incorporated herein by reference.

### BACKGROUND

1. Field of the Invention

The present invention disclosed herein relates to an interface technique, and more particularly, to an interface circuit, and a semiconductor memory chip and an operation processing device including the same.

2. Description of the Related Art

An interface circuit included in an electronic device is used to transmit/receive signals to/from another electronic device. For example, each of a memory device and a processor included in a computing system includes an interface circuit, which operates according to one or more communication protocols. The memory device and the processor transmit/receive signals through the interface circuit.

Computing systems being used in recent years include a main memory device, which operates at high speed, in order to process a large amount of data. For example, a synchronous dynamic random access memory (SDRAM), which operates according to double data rate (DDR) scheme in response to a clock signal having a frequency of hundreds megahertz (MHz) to thousands MHz, is mainly used as a main memory device of a computing system. A main memory device, such as an SDRAM operating according to DDR scheme, uses transmission lines having wide bandwidth of 32 bits or 64 bits to transmit/receive a large amount of data at high speed. Furthermore, an interface circuit uses transmission lines having bandwidth of more than 40 bits to transmit/receive a signal representing an address of a storage area or a control signal. Therefore, transmission lines used in a memory system may have bandwidth of more than 100 bits. Accordingly, as the line width of each transmission line increases, the complexity on a device configuration and a signal control increases. Moreover, when a plurality of interface circuits is included in a computing system, the complexity on a device configuration and a signal control further increases.

Recently, in order to process “big data”, a computing system having a high processing performance is being required. A computing system having a high processing performance includes a main memory device having a large capacity to process a lot of operations. In order to increase the capacity of a main memory device in a computing system, there are a method of increasing the capacity of a main memory device itself and a method of using a plurality of main memory devices. However, due to limitations in manufacturing processes, increasing the capacity of a main memory device itself is limited. In addition, when a plurality of main memory devices is used, a plurality of memory controllers and a plurality of interface circuits are further included, thus, the complexity on a device configuration and a signal control further increases.

Accordingly, a method of reducing the line width of a transmission line is required. If the line width of the transmission line is reduced, even when a plurality of main memory devices or a plurality of interface circuits is used, the complexity on a device configuration and a signal control does not significantly increase.

### SUMMARY

The present disclosure provides an interface circuit for converting data to be transmitted into parallel electrical signals in packet unit, serializing the parallel electrical signals, and converting the serialized electrical signals into optical signals. The present disclosure also provides a semiconductor memory chip and an operation processing device including such an interface circuit.

An example embodiment of the present invention may provide an interface circuit configured to transmit and receive signals between electronic devices. The interface circuit may include an optical connection protocol manager configured to serialize a parallel transmission packet electrical signal generated based on output data to generate a serialized transmission packet electrical signal, parallelize a serial reception packet electrical signal to generate a parallelized reception packet electrical signal, and parse the parallelized reception packet electrical signal according to whether there is an error in the parallelized reception packet electrical signal to generate input data; and an electro-optical converter configured to convert the serialized transmission packet electrical signal into a transmission packet optical signal to output the transmission packet optical signal, receive a reception packet optical signal, and convert the reception packet optical signal into the serial reception packet electrical signal to provide the serial reception packet electrical signal to the optical connection protocol manager.

An example embodiment of the present invention may provide a semiconductor memory chip. The semiconductor memory chip may include a memory cell array configured to store data; an optical connection protocol manager configured to serialize a parallel transmission packet electrical signal generated based on output data to generate a serialized transmission packet electrical signal, the output data being to be output from the memory cell array, parallelize a serial reception packet electrical signal to generate a parallelized reception packet electrical signal, and parse the parallelized reception packet electrical signal according to whether there is an error in the parallelized reception packet electrical signal to generate input data to be stored in the memory cell array; and an electro-optical converter configured to convert the serialized transmission packet electrical signal into a transmission packet optical signal to output the transmission packet optical signal, receive a reception packet optical signal, and convert the reception packet optical signal into the serial reception packet electrical signal to provide the serial reception packet electrical signal to the optical connection protocol manager; and a memory controller configured to control the memory cell array and the optical connection protocol manager in order to output the output data and store the input data.

An example embodiment of the present invention may provide an operation processing device. The operation processing device may include an operation memory configured to store data used to perform an operation; an optical connection protocol manager configured to serialize a parallel transmission packet electrical signal generated based on output data to generate a serialized transmission packet electrical signal, the output data being to be outputted from the operation memory, parallelize a serial reception packet electrical signal to generate a parallelized reception packet electrical signal, and parse the parallelized reception packet electrical signal according to whether there is an error in the parallelized reception packet electrical signal to generate input data to be stored in the operation memory; and an electro-optical converter configured to convert the serialized transmission packet electrical signal into a transmission packet optical signal to output the transmission packet optical signal, receive a reception packet optical signal, and convert the reception packet optical signal into the serial reception packet electrical signal to provide the serial reception packet electrical signal to the optical connection protocol manager.

### BRIEF DESCRIPTION OF THE DRAWINGS

The above and other aspects, features, and advantages of certain embodiments of the present invention will become apparent from the following detailed description with reference to the following figures, wherein like reference numerals refer to like parts throughout the various figures unless otherwise specified, and wherein:

FIG. 1 is a block diagram illustrating an electronic system including two electronic devices connected to each other according to an example embodiment of the present invention;

FIG. 2 is a block diagram illustrating an optical connection protocol manager according to an example embodiment of the present invention;

FIG. 3 is a conceptual diagram illustrating a parallel electrical signal in packet unit generated according to an example embodiment of the present invention;

FIG. 4 is a block diagram illustrating an optical connection protocol manager according to an example embodiment of the present invention;

FIG. 5 is a block diagram illustrating an optical connection protocol manager according to an example embodiment of the present invention;

FIG. 6 is a block diagram illustrating an optical connection protocol manager according to an example embodiment of the present invention;

FIG. 7 is a block diagram illustrating a semiconductor memory chip according to an example embodiment of the present invention;

FIG. 8 is a block diagram illustrating an optical connection protocol manager included in a semiconductor memory chip according to an example embodiment of the present invention;

FIG. 9 is a block diagram illustrating a computing system according to an example embodiment of the present invention;

FIG. 10 is a block diagram illustrating an optical connection protocol manager included in an operation processing device according to an example embodiment of the present invention;

FIGS. 11A and 11B are flowcharts illustrating a process of performing a data write operation according to an example embodiment of the present invention; and

FIGS. 12A and 12B are flowcharts illustrating a process of performing a data read operation according to an example embodiment of the present invention.

### DETAILED DESCRIPTION OF EMBODIMENTS

The above characteristics and following detailed description below are all exemplary details to help the description and understanding of the present invention. That is, the present invention is not limited to such example embodiments and realized in other forms. Rather, these example embodiments are provided so that this disclosure will be thorough and complete, and will fully convey the scope of the present invention to those skilled in the art. Accordingly, in the case that there are methods for implementing components of the present invention, it is necessary to clarify that any specific method or any method equivalent thereto is possible to realize the present invention.

The meaning of “include,” “comprise,” “including,” or “comprising,” specifies a property, a region, a fixed number, a step, a process, an element and/or a component but does not exclude other properties, regions, fixed numbers, steps, processes, elements and/or components. That is, the terminology used herein is not for delimiting various example embodiments of the present invention but for only describing specific example embodiments. An example embodiment described and exemplified herein includes a complementary embodiment thereof.

Otherwise indicated herein, all the terms used herein, which include technical or scientific terms, may have the same meaning that is generally understood by a person skilled in the art. In general, the terms defined in the dictionary should be considered to have the same meaning as the contextual meaning of the related art. Unless clearly defined herein, should not be understood abnormally or excessively formal meaning. Hereinafter, example embodiments of the present invention are described in detail with reference to the accompanying drawings.

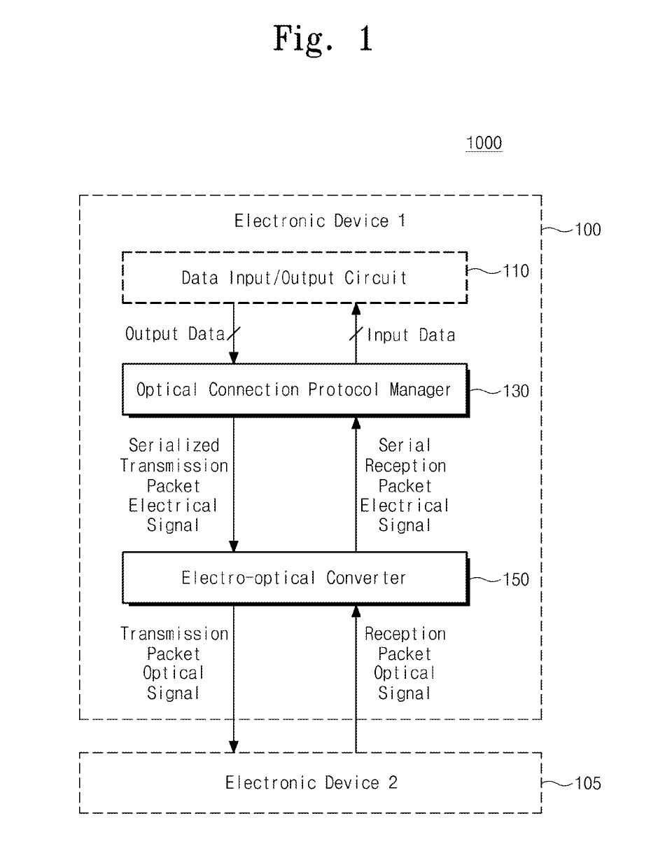

FIG. 1 is a block diagram illustrating an electronic system 1000 including two electronic devices connected to each other according to an example embodiment of the present invention. The electronic system 1000 may include a first electronic device 100 and a second electronic device 105.

The first electronic device 100 may include a data input/output circuit 110, an optical connection protocol manager 130, and an electro-optical converter 150. In particular, an interface circuit according to an example embodiment of the present invention may be configured to include the optical connection protocol manager 130 and the electro-optical converter 150. The interface circuit including the optical connection protocol manager 130 and the electro-optical converter 150 may be configured to transmit and receive signals between the data input/output circuit 110 of the first electronic device 100 and the second electronic device 105.

The data input/output circuit 110 may store data used in the first electronic device 100. For instance, when the first electronic device 100 is a semiconductor memory device, the data input/output circuit 110 may include a sense amplifier, which is configured to load data from a memory cell or store data in the memory cell. For instance, when the first electronic device 100 is a processor, the data input/output circuit 110 may include a cache memory, which is configured to store data used to perform an operation. The data input/output circuit 110 may store (e.g., temporarily store) data to be output to the outside of the first electronic device 100. The data input/output circuit 110 may provide output data to the optical connection protocol manager 130.

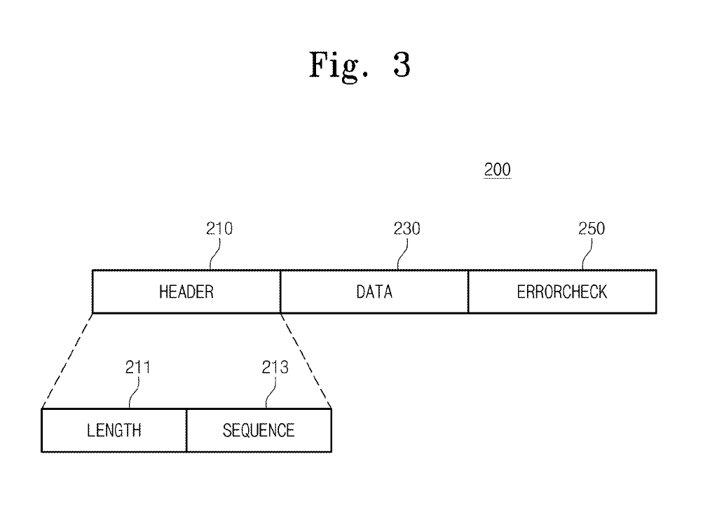

The optical connection protocol manager 130 may generate a transmission packet electrical signal based on the output data. The transmission packet electrical signal is an electrical signal in packet unit. The transmission packet electrical signal may be generated in parallel at first. A configuration of the parallel transmission packet electrical signal will be described with reference to FIG. 3. The optical connection protocol manager 130 may serialize the parallel transmission packet electrical signal to generate a serialized transmission packet electrical signal. The optical connection protocol manager 130 may output and provide the serialized transmission packet electrical signal to the electro-optical converter 150.

The electro-optical converter 150 may convert the serialized transmission packet electrical signal into a transmission packet optical signal. The electro-optical converter 150 may convert electrical signals into optical signals. The transmission packet optical signal is an optical signal used to deliver information included in the output data to the second electronic device 105. The electro-optical converter 150 may output and provide the transmission packet optical signal to the second electronic device 105.

The electro-optical converter 150 may receive a reception packet optical signal. The reception packet optical signal is an optical signal used to deliver information from the second electronic device 105 to the first electronic device 100. That is, the reception packet optical signal is an optical signal used to deliver information included in output data stored in a data input/output circuit (not shown) of the second electronic device 105 to the first electronic device 100. The electro-optical converter 150 may convert the reception packet optical signal into a reception packet electrical signal. The electro-optical converter 150 may convert optical signals into electrical signals. The reception packet electrical signal may be generated in series at first. The optical-optical converter 150 may provide the serial reception packet electrical signal to the optical connection protocol manager 130.

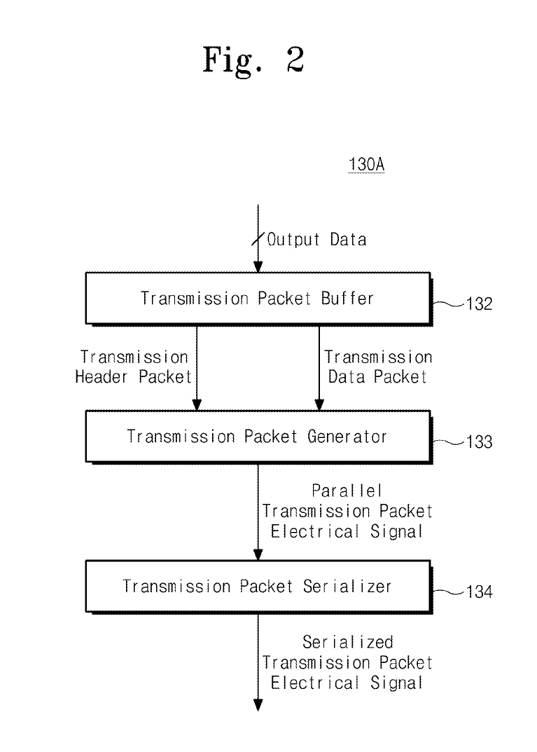

The optical connection protocol manager 130 may parallelize the serial reception packet electrical signal to generate a parallelized reception packet electrical signal. The parallelized reception packet electrical signal is an electrical signal in packet unit. A configuration of the parallelized reception packet electrical signal will be described with reference to FIGS. 3 5. The optical connection protocol manager 130 may test whether there is an error in the parallelized reception packet electrical signal. Descriptions associated with an error test will be mentioned with reference to FIGS. 2, 5, 11A, 11B, 12A, and 12B. When there is no error in the parallelized reception packet electrical signal, the optical connection protocol manager 130 may parse the parallelized reception packet electrical signal. The optical connection protocol manager 130 may generate input data based on a parsing result. The input data is data including information provided from the second electronic device 105 to the first electronic device 100. The optical connection protocol manager 130 may provide the input data to the data input/output circuit 110.

The data input/output circuit 110 may store the input data. The first electronic device 100 may perform an operation by itself by using the input data stored in the data input/output circuit 110. Alternatively, the first electronic device 100 may transmit another output data to the second electronic device 105 based on the input data stored in the data input/output circuit 110.

The second electronic device 105 may have the identical or similar configurations to the first electronic device 100. The second electronic device 105 may perform the identical or similar functions to the first electronic device 100. Detailed descriptions associated with the second electronic device 105 will be omitted.

According to the interface circuit (that is, a circuit including the optical connection protocol manager 130 and the electro-optical converter 150) shown in FIG. 1, an electrical signal in packet unit may be transmitted and received. In addition, according to the interface circuit shown in FIG. 1, one single transmission line used to transmit an optical signal and one single reception line used to receive an optical signal may be provided. Accordingly, the complexity on a device configuration and a signal control may be reduced.

FIG. 2 is a block diagram illustrating an optical connection protocol manager 130A according to an example embodiment of the present invention. An optical connection protocol manager 130 of FIG. 1 may include the optical connection protocol manager 130A. The optical connection protocol manager 130A may include a transmission packet buffer 132, a transmission packet generator 133, and a transmission packet serializer 134.

The transmission packet buffer 132 may receive output data including information to be output from an electronic device which includes the optical connection protocol manager 130A. The transmission packet buffer 132 may store a transmission header bit string and a transmission data bit string based on the output data. The transmission data bit string is a bit string to be included in a transmission data packet. The transmission data bit string may be generated based on information included in the output data. The transmission data packet may be generated based on information to be outputted from an electronic device including the optical connection protocol manager 130A. The transmission header bit string is a bit string to be included in a transmission header packet. The transmission header packet is a packet including information associated with a parallel transmission packet electrical signal. Descriptions associated with the information included in the transmission header packet will be mentioned with reference to FIG. 3.

When the transmission packet buffer 132 stores all transmission data bit strings to be included in the transmission data packet, the transmission packet buffer 132 may output the transmission data packet. Furthermore, when the transmission packet buffer 132 stores all transmission header bit strings to be included in the transmission header packet, the transmission packet buffer 132 may output the transmission header packet. The transmission packet buffer 132 may completely store one transmission header packet and/or one transmission data packet, and then may output the complete transmission header packet and/or transmission data packet. The transmission packet buffer 132 may provide the transmission header packet and the transmission data packet to the transmission packet generator 133.

The transmission packet generator 133 may generate data for error test. The data for error test may be generated based on the transmission header packet and the transmission data packet. For instance, the data for error test may be generated by using an error test algorithm, such as a parity test algorithm, a checksum algorithm, a cyclical redundancy check (CRC) algorithm, and so on. The above-mentioned error test algorithms are just examples, and it is apparent that the present invention is not limited thereto. The transmission packet generator 133 may generate a parallel transmission packet electrical signal by connecting the transmission header packet, the transmission data packet, and the data for error test. The transmission packet generator 133 may provide the parallel transmission packet electrical signal to the transmission packet serializer 134.

The transmission packet serializer 134 may serialize the parallel transmission packet electrical signal to generate a serialized transmission packet electrical signal. The serialized transmission packet electrical signal may be provided to the electro-optical converter 150 (see FIG. 1).

FIG. 3 is a conceptual diagram illustrating a parallel electrical signal 200 in packet unit generated according to an example embodiment of the present invention. The parallel electrical signal 200 in packet unit may be generated by connecting a header 210, information data 230, and data for error test 250. For instance, a parallel transmission packet electrical signal generated by a transmission packet generator 133 (see FIG. 2) may include the parallel electrical signal 200 in packet unit.

The header 210 may include information associated with the parallel electrical signal 200 in packet unit. As an example embodiment, the header 210 may include information 211 associated with the length of a bit string included in the parallel electrical signal 200 in packet unit. Further, when the data size of output data is large, the output data may be converted into a plurality of parallel electrical signals 200 in packet unit. In this case, as an example embodiment, the header 210 may include information 213 associated with the parsing order of each of the plurality of parallel electrical signals in packet unit. The header 210 may include at least one of the information 211 associated with the length of a bit sting and the information 213 associated with the parsing order. However, the configuration illustrated in FIG. 3 is just an example embodiment. The header 210 may further include other kinds of information. The header 210 may be configured based on a transmission header packet generated by a transmission packet buffer 132 (see FIG. 2).

The information data 230 may include the output data including information to be output from an electronic device. The information data 230 may be configured based on a transmission header packet generated by the transmission packet buffer 132.

The data for error test 250 may be used when an electronic device who receives the parallel electrical signal 200 in packet unit tests whether there is an error in the parallel electrical signal 200 in packet unit. The data for error test 250 may be generated by the transmission packet generator 133. The data for error test 250 may be generated based on the header 210 and the information data 230. As mentioned above, as an example embodiment, the data for error test 250 may be generated by using an error test algorithm, such as a parity test algorithm, a checksum algorithm, a CRC algorithm, and so on. An electronic device who receives the parallel electrical signal 200 in packet unit may test the validity of the header 210 and the information data 230 based on the data for error test 250.

However, a configuration of the parallel electrical signal 200 in packet unit illustrated in FIG. 3 is just an example to help understanding of the present invention. In some cases, the parallel electrical signal 200 in packet unit may not include some components shown in FIG. 3. As an example embodiment, when the parallel electrical signal 200 in packet unit is generated to simply control a device instead of delivering information, the parallel electrical signal 200 in packet unit may not include the information data 230. In addition, the parallel electrical signal 200 in packet unit may further include other components not shown in FIG. 3. As an example embodiment, when a semiconductor memory device is used as an electronic device, the header 210 may further include information associated with the address of a storage area which is an access target. Those skilled in the art may variously change or modify the configuration of the parallel electrical signals 200 in packet unit, as necessary. It is apparent that the present invention is not limited to the configuration illustrated in FIG. 3.

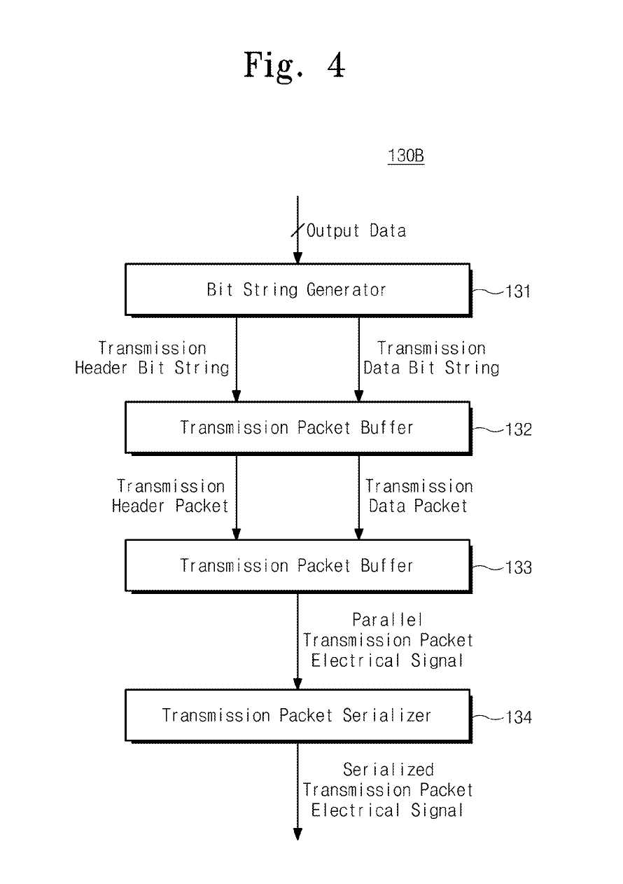

FIG. 4 is a block diagram illustrating an optical connection protocol manager 130B according to an example embodiment of the present invention. An optical connection protocol manager 130 of FIG. 1 may include the optical connection protocol manager 130B. The optical connection protocol manager 130B may include a bit string generator 131, a transmission packet buffer 132, a transmission packet generator 133, and a transmission packet serializer 134. Configurations and functions of the transmission packet buffer 132, the transmission packet generator 133, and the transmission packet serializer 134 in the optical connection protocol manager 130B may include configurations and functions of a transmission packet buffer 132, a transmission packet generator 133, and a transmission packet serializer 134 in an optical connection protocol manager 130A of FIG. 2, respectively. Detailed descriptions associated with the transmission packet buffer 132, the transmission packet generator 133, and the transmission packet serializer 134 will be omitted.

The bit string generator 131 may receive output data including information to be output from an electronic device which includes the optical connection protocol manager 130B. The bit string generator 131 may generate a transmission header bit string and a transmission data bit string based on the output data. The bit string generator 131 may provide the transmission header bit string and the transmission data bit string to the transmission packet buffer 132.

A difference between a configuration of the optical connection protocol manager 130A and a configuration of the optical connection protocol manager 130B is whether the bit string generator 131 is included or not. As an example embodiment, the optical connection protocol manager 130A may be included in a semiconductor memory device. When a semiconductor memory device is used as an electronic device, the output data may be directly stored in a storage area of the semiconductor memory device. Accordingly, the transmission packet buffer 132 may extract the transmission data bit string from the stored output data. On the other hand, the optical connection protocol manager 130B may be included in a processor. When the process is used as an electronic device, the transmission data bit string may be generated additionally if necessary. In this case, the additional transmission data bit string may be generated by the bit string generator 131.

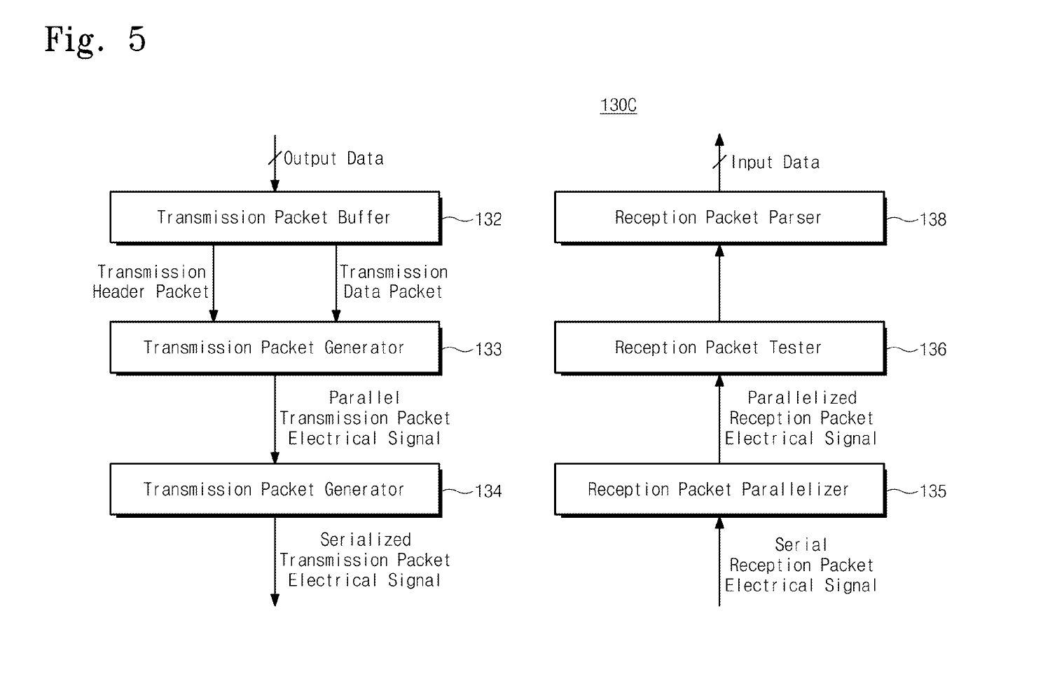

FIG. 5 is a block diagram illustrating an optical connection protocol manager 130C according to an example embodiment of the present invention. An optical connection protocol manager 130 of FIG. 1 may include the optical connection protocol manager 130C. The optical connection protocol manager 130C may include a transmission packet buffer 132, a transmission packet generator 133, a transmission packet serializer 134, a reception packet parallelizer 135, a reception packet tester 136, and a reception packet parser 138. Configurations and functions of the transmission packet buffer 132, the transmission packet generator 133, and the transmission packet serializer 134 in the optical connection protocol manager 130C may include configurations and functions of a transmission packet buffer 132, a transmission packet generator 133, and a transmission packet serializer 134 in an optical connection protocol manager 130A of FIG. 2, respectively. Detailed descriptions associated with the transmission packet buffer 132, the transmission packet generator 133, and the transmission packet serializer 134 will be omitted.

The reception packet parallelizer 135 may receive a serial reception packet electrical signal from the electro-optical converter 150 (see FIG. 1). The reception packet parallelizer 135 may parallelize the serial reception packet electrical signal to generate a parallelized reception packet electrical signal. As an example embodiment, the parallelized reception packet electrical signal may include a parallel electrical signal 200 in packet unit (see FIG. 3). The reception packet parallelizer 135 may provide the parallelized reception packet electrical signal to the reception packet tester 136.

The reception packet tester 136 may test whether there is an error in the parallelized reception packet electrical signal. The reception packet tester 136 may test whether there is an error by using an error test algorithm. The reception packet tester 136 may test the validity of a header 210 (see FIG. 3) and information data 230 (see FIG. 3) based on data for error test 250 (see FIG. 3) of the parallelized reception packet electrical signal. When there is no error in the parallelized reception packet electrical signal, the parallelized reception packet electrical signal may be provided to the reception packet parser 138.

The reception packet parser 138 may parse a reception header packet and a reception data packet included in the parallelized reception packet electrical signal. The reception header packet and the reception data packet may respectively correspond to a transmission header packet and a transmission data packet, which are generated by another electronic device delivering information to an electronic device including the optical connection protocol manager 130C. As an example embodiment, the reception header packet may include information associated with the length of a bit string corresponding to the parallelized reception packet electrical signal. When the data size of input data is large, a plurality of parallelized reception packet electrical signals may be used to generate and parse input data. In this case, as an example embodiment, the reception header packet may include information associated with the parsing order of each of the plurality of parallelized reception packet electrical signals. The reception header packet may include at least one of the information associated with the length of a bit sting and the information associated with the parsing order.

The reception packet parser 138 may parse the information included in the reception data packet by referring to the reception header packet. The reception packet parser 138 may generate the input data based on a parsing result. The input data may correspond to output data output from another electronic device delivering information to an electronic device including the optical connection protocol manager 130C.

When there is an error in the parallelized reception packet electrical signal, an operation for correcting the error may be performed. For instance, according to a control of the reception packet tester 136, a command for receiving the information from another electronic device delivering information to an electronic device including the optical connection protocol manager 130C may be generated. As an example embodiment, according to a control of the reception packet tester 136, the electronic device including the optical connection protocol manager 130C may output a transmission packet optical signal corresponding to a command for receiving the parallelized reception packet electrical signal having no error.

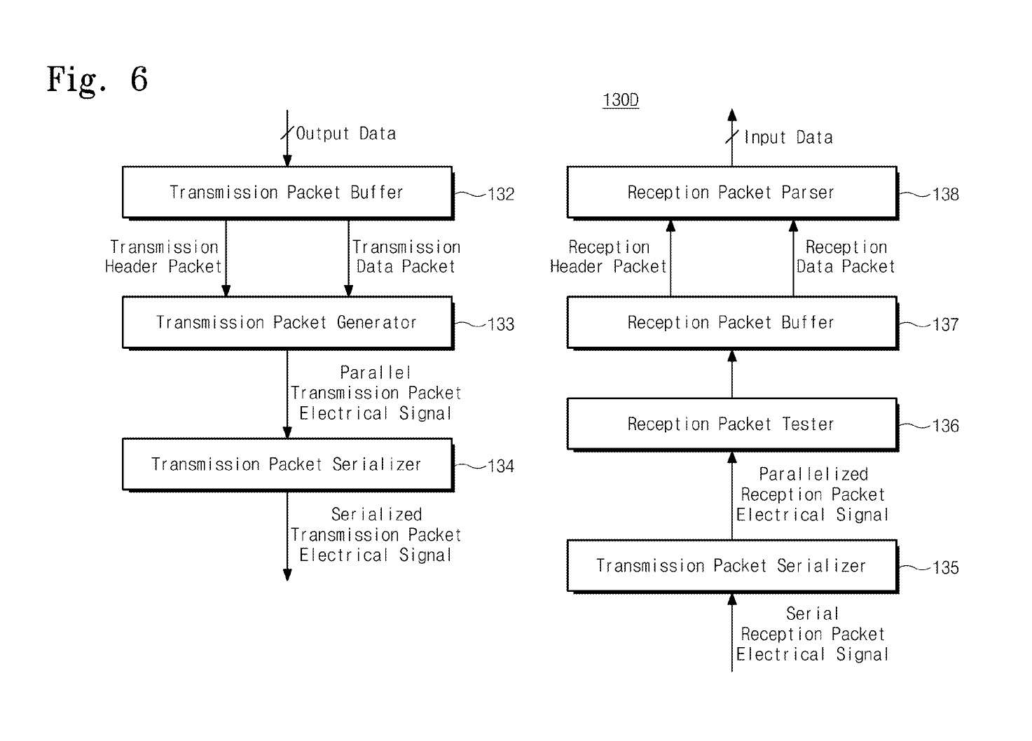

FIG. 6 is a block diagram illustrating an optical connection protocol manager 130D according to an example embodiment of the present invention. An optical connection protocol manager 130 of FIG. 1 may include the optical connection protocol manager 130D. The optical connection protocol manager 130D may include a transmission packet buffer 132, a transmission packet generator 133, a transmission packet serializer 134, a reception packet parallelizer 135, a reception packet tester 136, a reception packet buffer 137, and a reception packet parser 138.

Configurations and functions of the transmission packet buffer 132, the transmission packet generator 133, the transmission packet serializer 134, the reception packet parallelizer 135, the reception packet tester 136, and reception packet parser 138 in the optical connection protocol manager 130D may include configurations and functions of a transmission packet buffer 132, a transmission packet generator 133, a transmission packet serializer 134, a reception packet parallelizer 135, a reception packet tester 136, and a reception packet parser 138 in an optical connection protocol manager 130C of FIG. 5, respectively. Detailed descriptions associated with the transmission packet buffer 132, the transmission packet generator 133, the transmission packet serializer 134, the reception packet parallelizer 135, the reception packet tester 136, and the reception packet parser 138 will be omitted.

When there is no error in a parallelized reception packet electrical signal, the reception packet buffer 137 may receive the parallelized reception packet electrical signal from the reception packet tester 136. The reception packet buffer 137 may store a reception header packet and a reception data packet, which are included in the parallelized reception packet electrical signal. The reception packet buffer 137 may the reception header packet and the reception data packet to the reception packet parser 138.

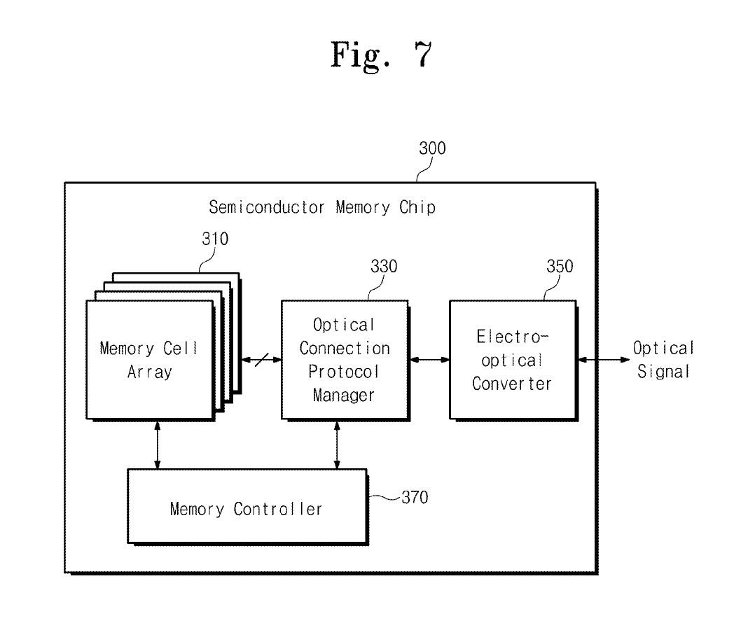

FIG. 7 is a block diagram illustrating a semiconductor memory chip 300 according to an example embodiment of the present invention. The semiconductor memory chip 300 may include a memory cell array 310, an optical connection protocol manager 330, an electro-optical converter 350, and a memory controller 370. In particular, the semiconductor memory chip 300 may include an interface circuit including the optical connection protocol manager 330 and the electro-optical converter 350 according to an example embodiment of the present invention.

The memory cell array 310 may store data. In particular, the memory cell array 310 may store output data to be delivered to the outside of the semiconductor memory chip 300. Additionally, the memory cell array 310 may store input data delivered from the outside of the semiconductor memory chip 300. Although not illustrated in FIG. 7, the semiconductor memory chip 300 may further include other components, such as a sense amplifier, a row decoder, and a column decoder, to store data in the memory cell array 310. However, for brevity of descriptions, descriptions associated with other components will be omitted, and it is described that the memory cell array 310 and the optical connection protocol manager 330 communicate with each other directly.

The optical connection protocol manager 330 may generate a transmission packet electrical signal based on the output data to be outputted from the memory cell array 310. The transmission packet electrical signal is an electrical signal in packet unit. The transmission packet electrical signal may be generated in parallel at first. A configuration of the parallel transmission packet signal has been described with reference to FIG. 3. The optical connection protocol manager 330 may serialize the parallel transmission packet electrical signal to generate a serialized transmission packet electrical signal. The optical connection protocol manager 330 may output and provide the serialized transmission packet electrical signal to the electro-optical converter 350.

The electro-optical converter 350 may convert the serialized transmission packet electrical signal into a transmission packet optical signal. The electro-optical converter 350 may convert electrical signals into optical signals. As mentioned above, the transmission packet optical signal is an optical signal used to deliver information included in the output data to another electronic device.

The electro-optical converter 350 may receive a reception packet optical signal. As mentioned above, the reception packet optical signal is an optical signal used to deliver information from another electronic device to the semiconductor memory chip 300. The electro-optical converter 350 may convert the reception packet optical signal into a reception packet electrical signal. The electro-optical converter 350 may convert optical signals into electrical signals. The reception packet electrical signal may be generated in series at first. The optical-optical converter 350 may provide the serial reception packet electrical signal to the optical connection protocol manager 330.

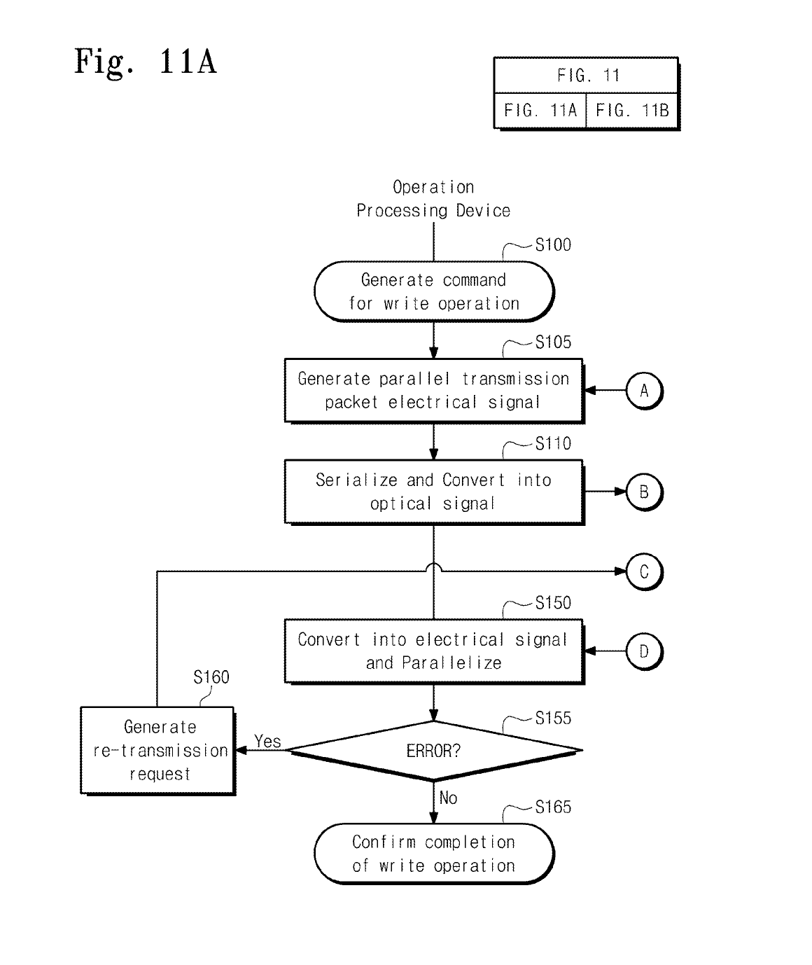

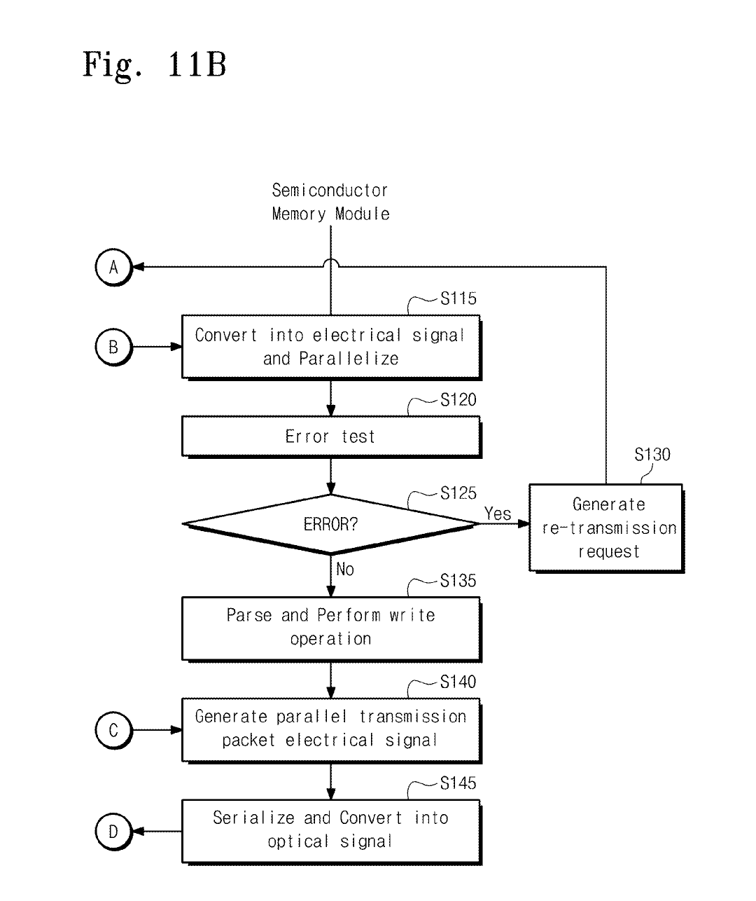

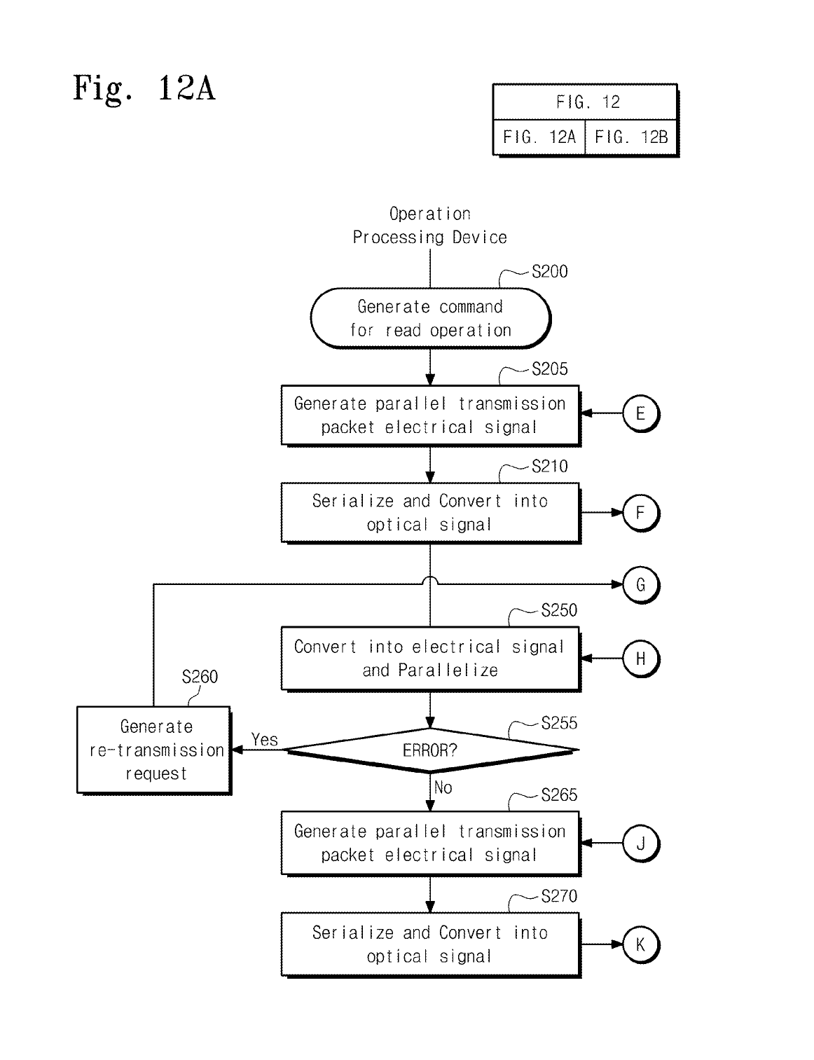

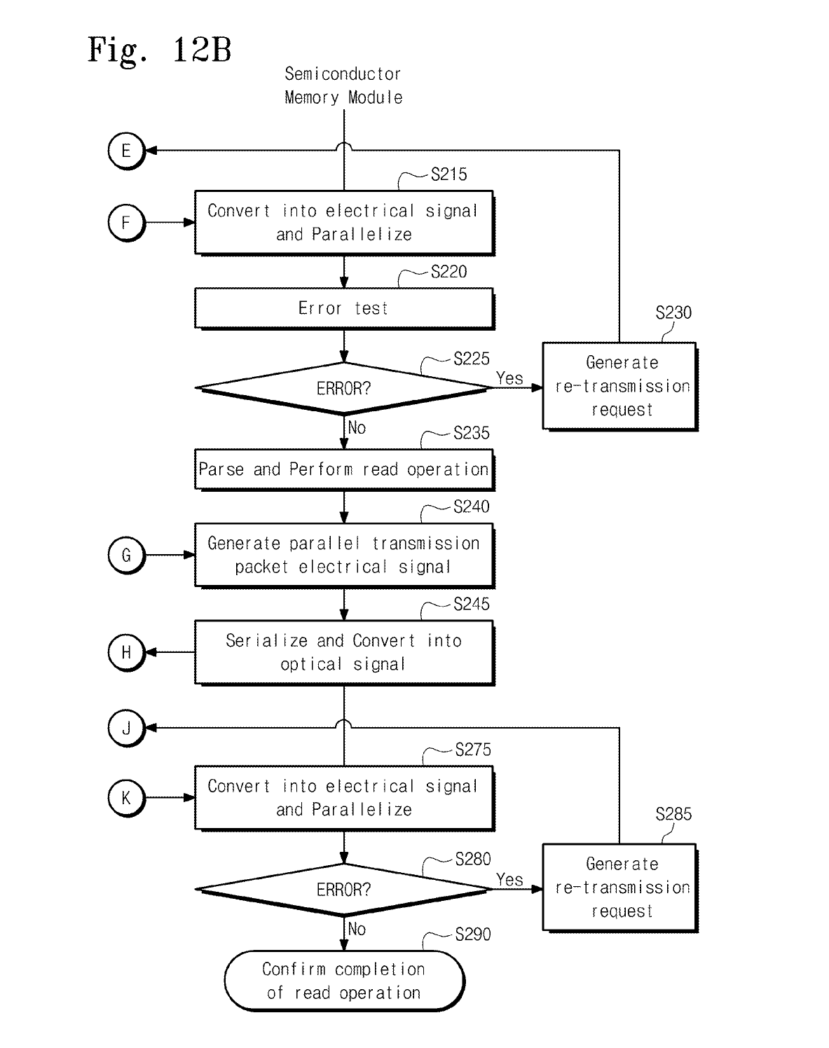

The optical connection protocol manager 330 may parallelize the serial reception packet electrical signal to generate a parallelized reception packet electrical signal. The parallelized reception packet electrical signal is an electrical signal in packet unit. A configuration of the parallelized reception packet electrical signal has been described with reference to FIGS. 3 5. The optical connection protocol manager 330 may test whether there is an error in the parallelized reception packet electrical signal. Descriptions associated with an error test will be mentioned with reference to FIGS. 11A, 11B, 12A, and 12B. When there is no error in the parallelized reception packet electrical signal, the optical connection protocol manager 330 may parse the parallelized reception packet electrical signal. The optical connection protocol manager 330 may generate the input data to be stored in the memory cell array 310 based on a parsing result. As mentioned above, the input data is data including information provided from another electronic device to the semiconductor memory chip 300.

The memory controller 370 may control the memory cell array 310 and the optical connection protocol manager 330. The memory controller 370 may control an output of output data. The memory controller 370 may control storing of input data.

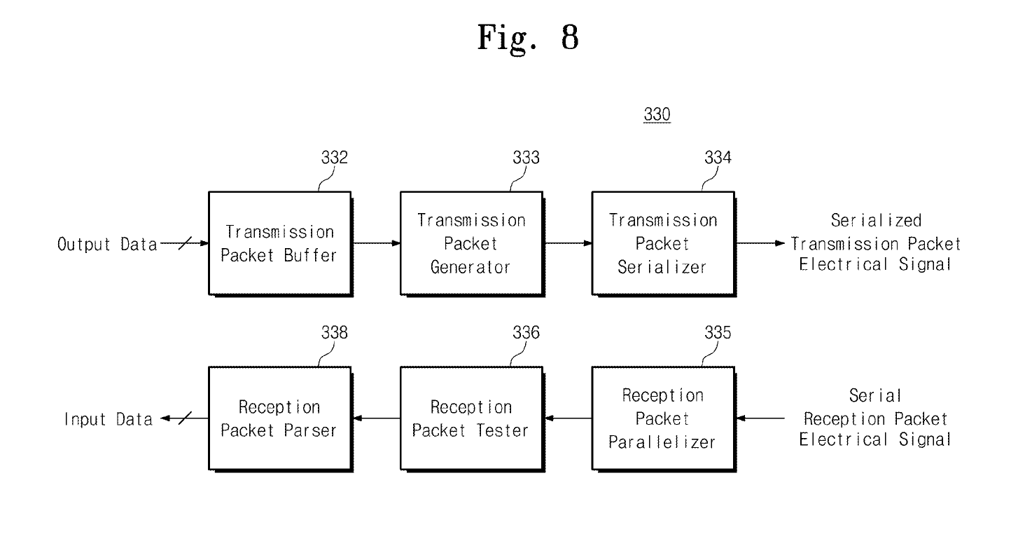

FIG. 8 is a block diagram illustrating an optical connection protocol manager 330 included in a semiconductor memory chip 300 according to an example embodiment of the present invention. An optical connection protocol manager 330 may include a transmission packet buffer 332, a transmission packet generator 333, a transmission packet serializer 334, a reception packet parallelizer 335, a reception packet tester 336, and a reception packet parser 338.

The transmission packet buffer 332 may receive output data to be outputted from the memory cell array 310 (see FIG. 7) of the semiconductor memory chip 300 (see FIG. 7). The transmission packet buffer 332 may store a transmission header bit string and a transmission data bit string based on the output data. The transmission data bit string is a bit string to be included in a transmission data packet. The transmission data bit string may be generated based on information included in the output data. The transmission header bit string is a bit string to be included in a transmission header packet. The transmission header packet is a packet including information associated with a parallel transmission packet electrical signal. Descriptions associated with the information included in the transmission header packet have been mentioned with reference to FIG. 3.

When the transmission packet buffer 332 stores all transmission data bit strings to be included in the transmission data packet, the transmission packet buffer 332 may output the transmission data packet. Furthermore, when the transmission packet buffer 332 stores all transmission header bit strings to be included in the transmission header packet, the transmission packet buffer 332 may output the transmission header packet. The transmission packet buffer 332 may completely store one transmission header packet and/or one transmission data packet, and then may output the completed transmission header packet and/or transmission data packet. According to the above configuration, unlike a synchronous dynamic random access memory (SDRAM) operating according to double data rate (DDR) scheme, a prefetch operation does not need to be performed. Therefore, according to the above configuration, the input/output speed of data may become faster in the semiconductor memory chip 300. The transmission packet buffer 332 may provide the transmission header packet and the transmission data packet to the transmission packet generator 333.

The transmission packet generator 333 may generate data for error test. The data for error test may be generated based on the transmission header packet and the transmission data packet. As an example embodiment, the data for error test may be generated by using an error test algorithm, such as a parity test algorithm, a checksum algorithm, a CRC algorithm, and so on. The transmission packet generator 333 may generate the parallel transmission packet electrical signal by connecting the transmission header packet, the transmission data packet, and the data for error test. The transmission packet generator 333 may provide the parallel transmission electrical signal to the transmission packet serializer 334.

The transmission packet serializer 334 may serialize the parallel transmission packet electrical signal to generate a serialized transmission packet electrical signal. The serialized transmission packet electrical signal may be provided to the electro-optical converter 350 (see FIG. 7). As mentioned above, the electro-optical converter 350 may convert the serialized transmission packet electrical signals into a transmission packet optical signal.

According to the above configuration, an electrical signal in packet unit may be transferred inside the semiconductor memory chip 300. According to the above configuration, the semiconductor memory chip 300 may transmit/receive information to/from another electronic device by using an optical signal. According to the above configuration, one single transmission line used to transmit an optical signal and one single reception line used to receive an optical signal may be provided. According to the above configuration, unlike a SDRAM operating according to DDR scheme, a termination resistance, which is connected to prevent an electrical signal from being reflected at a circuit terminal, does not need to be connected to the circuit terminal. Accordingly, the complexity on a device configuration and a signal control may be reduced.

The reception packet parallelizer 335 may receive a serial reception packet electrical signal from the electro-optical converter 350. The reception packet parallelizer 335 may parallelize the serial reception packet electrical signal to generate a parallelized reception packet electrical signal. As an example embodiment, the parallelized reception packet electrical signal may include a parallel electrical signal 200 in packet unit (see FIG. 3). The reception packet parallelizer 335 may provide the parallelized reception packet electrical signal to the reception packet tester 336.

The reception packet tester 336 may test whether there is an error in the parallelized reception packet electrical signal. The reception packet tester 336 may test whether there is an error by using an error test algorithm. The reception packet tester 336 may test the validity of a header 210 (see FIG. 3) and information data 230 (see FIG. 3) based on data for error test 250 (see FIG. 3) of the parallelized reception packet electrical signal. When there is no error in the parallelized reception packet electrical signal, the parallelized reception packet electrical signal may be provided to the reception packet parser 338.

The reception packet parser 338 may parse a reception header packet and a reception data packet, which are included in the parallelized reception packet electrical signal. The reception header packet and the reception data packet may respectively correspond to a transmission header packet and a transmission data packet generated by another electronic device delivering information to the semiconductor memory chip 300.

As an example embodiment, the reception header packet may include information associated with the length of a bit string corresponding to the parallelized reception packet electrical signal. When the size of the input data is large, a plurality of parallelized reception packet electrical signals may be used to generate the input data. In this case, as an example embodiment, the reception header packet may include information associated with a parsing order of each of the plurality of parallelized reception packet electrical signals. Furthermore, the reception header packet may include information associated with the type of an operation to be performed in the semiconductor memory chip 300. For instance, the reception header packet may include information associated with whether a read operation or a write operation is performed in the semiconductor memory chip 300. In addition, the reception header packet may include information associated with the address of a storage area of the memory cell array 310 where an operation is to be performed in the semiconductor memory chip 300. The reception header packet may include at least one of the information associated with the length of a bit sting, the information associated with the parsing order, the information associated with the type of an operation, and the information associated with the address of a storage area.

The reception packet parser 338 may parse the information included in the reception data packet by referring to the reception header packet. The reception packet parser 338 may generate the input data based on a parsing result. The input data may correspond to output data of another electronic device delivering information to the semiconductor memory chip 300.

When there is an error in the parallelized reception packet electrical signal, an operation for correcting the error may be performed. For instance, according to a control of the reception packet tester 336, a command for receiving the information from another electronic device delivering information to the semiconductor memory chip 300 may be generated. As an example embodiment, according to a control of the reception packet tester 336, the semiconductor memory chip 300 may output the transmission packet optical signal corresponding to a command for receiving the parallelized reception packet electrical signal having no error.

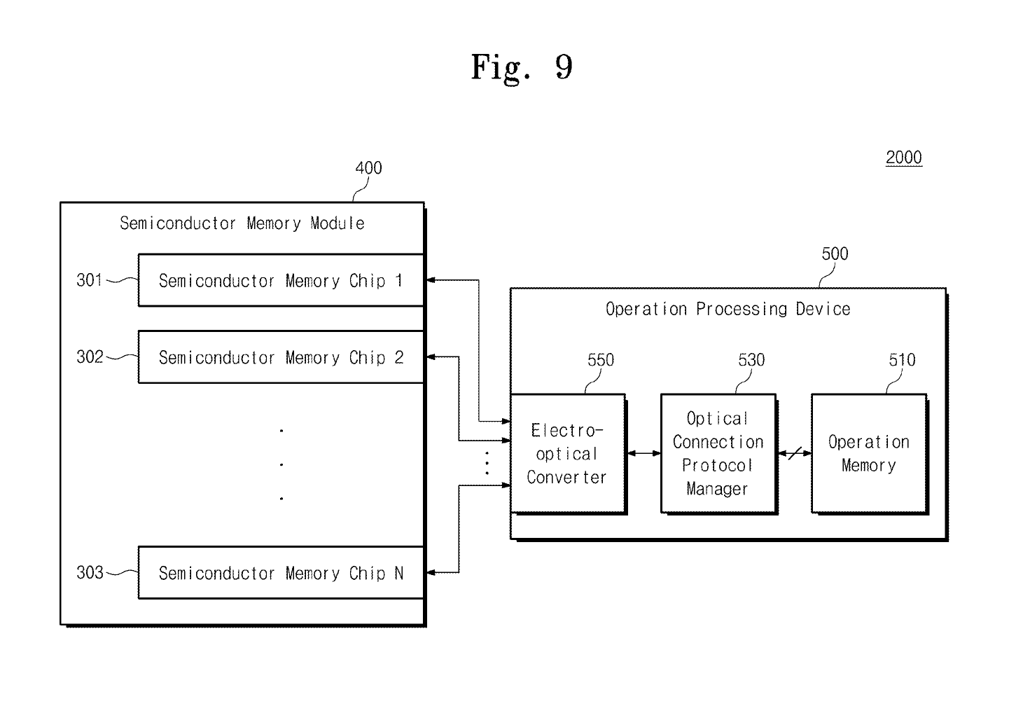

FIG. 9 is a block diagram illustrating a computing system 2000 according to an example embodiment of the present invention. An electronic system 2000 may include a semiconductor memory module 400 and an operation processing device 500.

As an example embodiment, the semiconductor memory module 400 may be used as a main memory of the computing system 2000. The semiconductor memory module 400 may include N semiconductor memory chips 301, 302, and 303. Each of the N semiconductor memory chips 301, 302, and 303 may be implemented according to the configurations illustrated in FIGS. 7 and 8. Each of the N semiconductor memory chips 301, 302, and 303 may perform the functions described with reference to FIGS. 7 and 8. Detailed descriptions associated with the N semiconductor memory chips 301, 302, and 303 and the semiconductor memory module 400 will be omitted.

As an example embodiment, the operation processing device 500 may be used as a processor of the computing system 2000. In this example embodiment, the operation processing device 500 may be a general-purpose processor, a workstation processor, or an application processor. The operation processing device 500 may include an operation memory 510, an optical connection protocol manager 530, and an electro-optical converter 550. In particular, the operation processing device 500 may include an interface circuit including the optical connection protocol manager 530 and the electro-optical converter 550 according to an example embodiment of the present invention. The operation processing device 500 may transmit/receive information to/from each of the N semiconductor memory chips 301, 302, and 303 through the interface circuit.

The operation memory 510 may store data used to perform an operation. In particular, the operation memory 510 may store output data to be delivered to the outside of the operation processing device 500. Additionally, the operation memory 510 may store input data delivered from the outside of the operation processing device 500. As an example embodiment, when the operation processing device 500 is a processor, the operation memory 510 may include a cache memory. The operation processing device 510 may provide the output data to the optical connection protocol manager 530.

As an example embodiment, the output data may be data to be stored in the semiconductor memory module 400. In this example embodiment, the operation memory 510 may further provide control information, which indicates that an operation to be performed in the semiconductor memory module 400 is a write operation, to the optical connection protocol manager 530. Furthermore, in this example embodiment, the operation memory 510 may further provide information, which is associated with the address of a storage area in the semiconductor memory module 400 where the output data is to be stored, to the optical connection protocol manager 530.

As an example embodiment, the operation processing device 500 may read data stored in the semiconductor memory module 400. In this example embodiment, the operation memory 510 may further provide control information, which indicates that an operation to be performed in the semiconductor memory module 400 is a read operation, to the optical connection protocol manager 530. Furthermore, in this example embodiment, the operation memory 510 may further provide information, which is associated with the address (in particular, a logical address) of a storage area in the semiconductor memory module 400 where data to be read is stored, to the optical connection protocol manager 530.

The optical connection protocol manager 530 may generate a transmission packet electrical signal based on the output data. The transmission packet electrical signal is an electrical signal in packet unit. The transmission packet electrical signal may be generated in parallel at first. A configuration of the parallel transmission packet signal has been mentioned with reference to FIG. 3. The optical connection protocol manager 530 may serialize the parallel transmission packet electrical signal to generate a serialized transmission packet electrical signal. The optical connection protocol manager 530 may output and provide the serialized transmission packet electrical signal to the electro-optical converter 550.

The electro-optical converter 550 may convert the serialized transmission packet electrical signal into a transmission packet optical signal. The electro-optical converter 550 may convert electrical signals into optical signals. The transmission packet optical signal is an optical signal used to deliver information included in the output data to the semiconductor memory module 400. The electro-optical converter 550 may output and provide the transmission packet optical signal to the semiconductor memory module 400.

The electro-optical converter 550 may receive a reception packet optical signal from the semiconductor memory module 400. The reception packet optical signal is an optical signal used to receive information from the semiconductor memory module 400 by the operation processing device 500. The electro-optical converter 550 may convert the reception packet optical signal into a reception packet electrical signal. The electro-optical converter 550 may convert optical signals into electrical signals. The reception packet electrical signal may be generated in series at first. The optical-optical converter 550 may provide the serial reception packet electrical signal to the optical connection protocol manager 530.

The optical connection protocol manager 530 may parallelize the serial reception packet electrical signal to generate a parallelized reception packet electrical signal. The parallelized reception packet electrical signal is an electrical signal in packet unit. A configuration of the parallelized reception packet electrical signal has been mentioned with reference to FIGS. 3 and 5. The optical connection protocol manager 530 may test whether there is an error in the parallelized reception packet electrical signal. Descriptions associated with an error test will be mentioned with reference to FIGS. 11A, 11B, 12A, and 12B. When there is no error in the parallelized reception packet electrical signal, the optical connection protocol manager 530 may parse the parallelized reception packet electrical signal. The optical connection protocol manager 530 may generate the input data to be stored in the operation memory 510 based on a parsing result. The input data is data including information provided from the semiconductor memory module 400 to the operation processing device 500.

As an example embodiment, when the operation processing device 500 reads data stored in the semiconductor memory module 400, the operation memory 510 may store the input data. The operation processing device 500 may perform an operation by itself by using the input data stored in the operation memory 510. Alternatively, the operation processing device 500 may transmit another output data to the semiconductor memory module 400 or another electronic device based on the input data stored in the operation memory 510. As an example embodiment, when the operation processing device 500 stores data in the semiconductor memory module 400, the input data may include information associated with whether a write operation is performed successfully.

According to the above configuration, an electrical signal in packet unit may be transferred inside the operation processing device 500. According to the above configuration, one single transmission line used to transmit an optical signal and one single reception line used to receive an optical signal may be provided between each of the N semiconductor memory chips 301, 302, and 303 and the electro-optical converter 550. Accordingly, the complexity on a device configuration and a signal control may be reduced. Furthermore, since the line width of the transmission line is reduced and a device configuration becomes simpler, the operation processing device 500 may be connected to much more semiconductor memory chips. As a result, the computing system 2000 having high processing performance may be obtained.

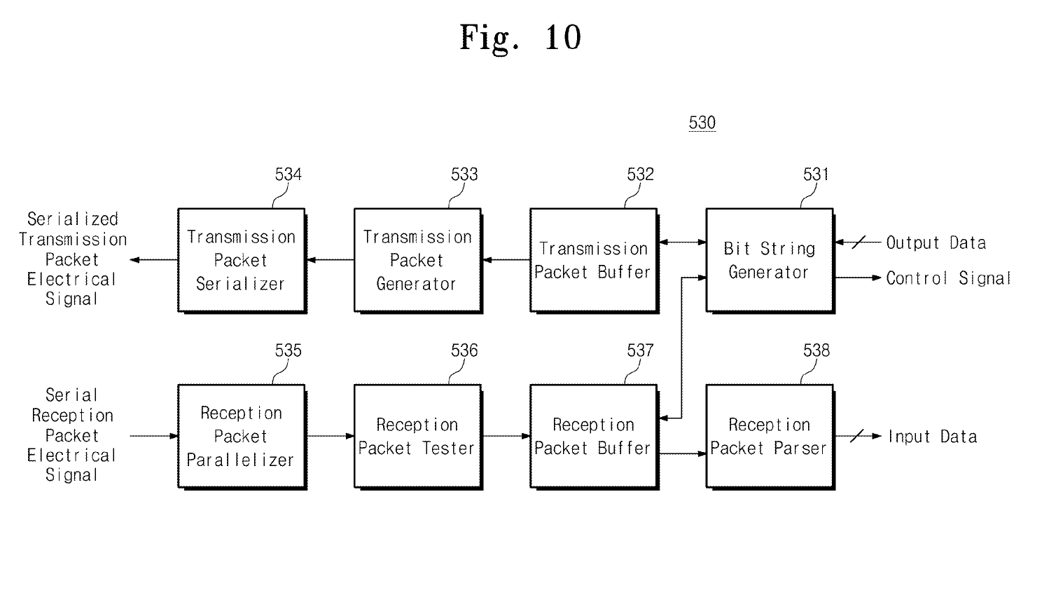

FIG. 10 is a block diagram illustrating an optical connection protocol manager 530 included in an operation processing device 500 according to an example embodiment of the present invention. An optical connection protocol manager 530 may include a bit string generator 531, a transmission packet buffer 532, a transmission packet generator 533, a transmission packet serializer 534, a reception packet parallelizer 535, a reception packet tester 536, a reception packet buffer 537, and a reception packet parser 538.

The bit string generator 531 may receive output data including information to be output from the operation memory 510 (see FIG. 9) of the operation processing device 500 (see FIG. 9). The bit string generator 531 may generate a transmission header bit string and a transmission data bit string based on the output data. The transmission data bit string is a bit string to be included in a transmission data packet. The transmission data bit string may be generated based on information included in the output data. The transmission header bit string is a bit string to be included in a transmission header packet. The transmission header packet is a packet including information associated with a parallel transmission packet electrical signal. Descriptions associated with the information included in the transmission header packet have been mentioned with reference to FIG. 3. The bit string generator 531 may provide the transmission header bit string and the transmission data bit string to the transmission packet buffer 532.

The transmission packet buffer 532 may store the transmission header bit string and the transmission data bit string. When the transmission packet buffer 332 stores all transmission data bit strings to be included in the transmission data packet, the transmission packet buffer 332 may output the transmission data packet. Furthermore, when the transmission packet buffer 332 stores all transmission header bit strings to be included in the transmission header packet, the transmission packet buffer 332 may output the transmission header packet. The transmission packet buffer 332 may completely store one transmission header packet and/or one transmission data packet, and then may output the completed transmission header packet and/or transmission data packet.

As an example embodiment, the transmission packet buffer 532 may notify a usage of one or more buffer areas to the bit string generator 531. Alternatively, the bit string generator 531 may monitor a usage of one or more buffer areas in the transmission packet buffer 532. Whether all buffer areas of the transmission packet buffer 532 are in use or not may be monitored. When all buffer areas of the transmission packet buffer 532 are in use, an additional transmission header bit string or transmission data bit string may not be provided to the transmission packet buffer 532. On the other hand, when one or more buffer areas of the transmission packet buffer 532 are not in use, an additional transmission header bit string or transmission data bit string may be provided to the transmission packet buffer 532. In order to achieve this, the bit string generator 531 may transmit a control signal for requesting the next output data to the operation memory 510.

The transmission packet generator 533 may generate data for error test. The data for error test may be generated based on the transmission header packet and the transmission data packet. As an example embodiment, the data for error test may be generated by using an error test algorithm, such as a parity test algorithm, a checksum algorithm, a CRC algorithm, and so on. The transmission packet generator 533 may generate the parallel transmission packet electrical signal by connecting the transmission header packet, the transmission data packet, and the data for error test. The transmission packet generator 533 may provide the parallel transmission electrical signal to the transmission packet serializer 534.

The transmission packet serializer 534 may serialize the parallel transmission packet electrical signal to generate a serialized transmission packet electrical signal. The serialized transmission packet electrical signal may be provided to the electro-optical converter 550 (see FIG. 9). As mentioned above, the electro-optical converter 550 may convert the serialized transmission packet electrical signal into a transmission packet optical signal.

The reception packet parallelizer 535 may receive a serial reception packet electrical signal from the electro-optical converter 550. The reception packet parallelizer 535 may parallelize the serial reception packet electrical signal to generate a parallelized reception packet electrical signal. As an example embodiment, the parallelized reception packet electrical signal may include a parallel electrical signal 200 in packet unit (see FIG. 3). The reception packet parallelizer 535 may provide the parallelized reception packet electrical signal to the reception packet tester 536.

The reception packet tester 536 may test whether there is an error in the parallelized reception packet electrical signal. The reception packet tester 536 may test whether there is an error by using an error test algorithm. The reception packet tester 536 may test the validity of a header 210 (see FIG. 3) and information data 230 (see FIG. 3) based on data for error test 250 (see FIG. 3) of the parallelized reception packet electrical signal. When there is no error in the parallelized reception packet electrical signal, the parallelized reception packet electrical signal may be provided to the reception packet buffer 537.

The reception packet buffer 537 may store a reception header packet and a reception data packet included in the parallelized reception packet electrical signal. As an example embodiment, the reception packet buffer 537 may notify a usage of buffer areas to the bit string generator 531. Alternatively, the bit string generator 531 may monitor a usage of buffer areas in the reception packet buffer 537. Whether all buffer areas of the reception packet buffer 537 are in use or not may be monitored. When all buffer areas of the reception packet buffer 537 are in use, an additional transmission header bit string or transmission data bit string may not be provided to the transmission packet buffer 532. On the other hand, when one or more buffer areas of the reception packet buffer 537 are not in use, an additional transmission header bit string or transmission data bit string may be provided to the transmission packet buffer 532. In order to achieve this, the bit string generator 531 may transmit a control signal for requesting the next output data to the operation memory 510. The reception packet buffer 537 may provide the reception header packet and the reception data packet to the reception packet parser 538.

The reception packet parser 538 may parse the reception header packet and the reception data packet. The reception header packet and the reception data packet may respectively correspond to a transmission header packet and a transmission data packet generated in the semiconductor memory module 400. As an example embodiment, the reception header packet may include information associated with the length of a bit string corresponding to the parallelized reception packet electrical signal. When the size of the input data is large, a plurality of parallelized reception packet electrical signals may be used to generate the input data. In this case, as an example embodiment, the reception header packet may include information associated with a parsing order of each of the plurality of parallelized reception packet electrical signals. The reception packet parser 538 may parse the information included in the reception data packet by referring to the reception header packet. The reception packet parser 538 may generate the input data based on a parsing result. The input data may correspond to output data of the semiconductor memory module 400.

When there is an error in the parallelized reception packet electrical signal, an operation for correcting the error may be performed. For instance, according to a control of the reception packet tester 536, the operation processing device 500 may generate a command for receiving information from the semiconductor memory module 400. As an example embodiment, according to a control of the reception packet tester 536, the operation processing device 500 may output a transmission packet optical signal corresponding to a command for receiving the parallelized reception packet electrical signal having no error.

FIGS. 11A and 11B are flowcharts illustrating a process of performing a data write operation according to an example embodiment of the present invention. FIGS. 11A and 11B are connected through nodes A, B, C, and D. With reference to FIGS. 11A and 11B, the process that the operation processing device 500 (see FIG. 9) writes data in the N memory chips 301, 302, and 303 (see FIG. 9) included in the semiconductor memory module 400 (see FIG. 9) is described. In order to help understanding of the present invention, FIGS. 7 to 10 are referred together.

In operation S100, a command for a write operation may be generated. As the command is generated, the operation memory 510 may transmit output data to the bit string generator 531. The output data may be data to be stored in the semiconductor memory module 400. The output data may be input data in view of the semiconductor memory module 400. Furthermore, the output data may include information indicating that an operation to be performed in the semiconductor memory module 400 is a write operation, information associated with the length of data, information associated with the address of a storage area where the write operation is to be performed in the semiconductor memory module 400, and so on. However, the configuration of the output data may be variously changed or modified as necessary, and the present invention is not limited thereto.

In operation S105, a parallel transmission packet electrical signal may be generated. The optical connection protocol manager 530 may generate the parallel transmission packet electrical signal based on the output data. According to an example embodiment of the present invention, an electrical signal is transmitted and received in packet unit. The transmission packet buffer 532 may output a completed electrical signal when all bit strings for forming the electrical signal are stored. Herein, when buffer areas in the transmission packet buffer 532 are not fully in use, a bit string for forming an additional electrical signal may be further provided to the transmission packet buffer 532. The transmission packet generator 533 may generate the parallel transmission packet electrical signal by connecting a transmission header packet, a transmission data packet, and data for error test.

In operation S110, the parallel transmission packet electrical signal may be serialized, and a serialized transmission packet electrical signal may be generated. Furthermore, the serialized transmission packet electrical signal may be converted into a transmission packet optical signal. Herein, speed for serializing the parallel transmission packet electrical signal by the transmission packet serializer 534 needs to be designed to correspond to the bandwidth characteristic of the electro-optical converter 550. If speed for serializing the parallel transmission packet electrical signal by the transmission packet serializer 534 is relatively fast, a plurality of electro-optical converters 550 may be provided, as necessary. The transmission packet optical signal may be transmitted to the semiconductor memory module 400 (see the node B). The transmission packet optical signal may be a reception packet optical signal in view of the semiconductor memory module 400.

In operation S115, the reception packet optical signal may be converted into a serial reception packet electrical signal. Furthermore, the serial reception packet electrical signal may be parallelized by the reception packet parallelizer 335, and then a parallelized reception packet electrical signal may be generated.

In operation S120, whether there is an error in the parallelized reception packet electrical signal may be tested. The reception packet tester 336 may test whether there is an error in the parallelized reception packet electrical signal by using an error test algorithm. Whether there is an error may be tested based on the data for error test, which is generated by the transmission packet generator 533.

In operation S125, whether there is an error may be determined. When there is an error, a re-transmission request may be generated in operation S130. As an example embodiment, according to a control of the reception packet tester 336, the semiconductor memory module 400 may transmit a signal, which corresponds to a command for receiving the parallelized reception packet electrical signal having no error, to the operation processing device 500. In this case, operation S105 may be performed again (see the node A). However, when there is no error, operation S135 may be performed.

In operation S135, the parallelized reception packet electrical signal may be parsed. Furthermore, input data generated based on a parsing result may be stored in the semiconductor memory module 400. In particular, a write operation performed in the semiconductor memory module 400 may be performed based on information included in a reception header packet. Descriptions associated with information included in the reception header packet have been mentioned with reference to FIGS. 3 and 5. As an example embodiment, even when there is no error in the parallelized reception packet electrical signal but redundant information is delivered, the input data may be erased.

In operation S140, a parallel transmission packet electrical signal may be generated. The parallel transmission packet electrical signal generated in operation S140 may be a parallel electrical signal in packet unit to notify to the operation processing device 500 that a write operation is performed successfully. A process of generating the parallel transmission packet electrical signal in each of the N semiconductor memory chips 301, 302, and 303 in the semiconductor memory module 400 has been mentioned with reference to FIGS. 7 and 8.

In operation S145, the parallel transmission packet electrical signal may be serialized, and then a serialized transmission packet electrical signal may be generated. Furthermore, the serialized transmission packet electrical signal may be converted into a transmission packet optical signal. Herein, speed for serializing the parallel transmission packet electrical signal by the transmission packet serializer 334 needs to be designed to correspond to the bandwidth characteristic of the electro-optical converter 350. If speed for serializing the parallel transmission packet electrical signal by the transmission packet serializer 334 is relatively fast, a plurality of electro-optical converters 350 may be provided as necessary. The transmission packet optical signal may be transmitted to the operation processing device 500 (see the node D). The transmission packet optical signal may be a reception packet optical signal in view of the operation processing device 500.

In operation S150, the reception packet optical signal may be converted into a serial reception packet electrical signal. Furthermore, the serial reception packet electrical signal may be parallelized, and then a parallelized reception packet electrical signal may be generated. In operation S155, whether there is an error in the parallelized reception packet electrical signal may be determined. When there is an error, a re-transmission request may be generated in operation S160. In this case, operation S140 may be performed again (see the node C). However, when there is no error, operation S165 may be performed.

As an example embodiment, the operation processing device 500 may stand by until the parallelized reception packet electrical signal having no error is provided. Furthermore, when a standing-by time of the operation processing device 500 exceeds a critical value, the operation processing device 500 may determine that there is an error in the re-transmission request and generate the re-transmission request again.

In operation S165, it may be confirmed that a write operation is performed successfully. Once the write operation is completed, the process illustrated in FIGS. 11A and 11B may be terminated. However, when another write operation command is generated, the process illustrated in FIGS. 11A and 11B may be performed repeatedly.

FIGS. 12A and 12B are flowcharts illustrating a process of performing a data read operation according to an example embodiment of the present invention. FIGS. 12A and 12B are connected through nodes E, F, G, H, J, and K. With reference to FIGS. 12A and 12B, the process that the operation processing device 500 (see FIG. 9) reads data from the N memory chips 301, 302, and 303 (see FIG. 9) included in the semiconductor memory module 400 (see FIG. 9) is described. In order to help understanding of the present invention, FIGS. 7 to 10 are referred together.

In operation S200, a command for read operation may be generated. As the command is generated, the operation memory 510 may transmit output data to the bit string generator 531. The output data may be input data in view of the semiconductor memory module 400. The output data may include information indicating that an operation to be performed in the semiconductor memory module 400 is a read operation, information associated with the length of data, information associated with the address of a storage area where the read operation is to be performed in the semiconductor memory module 400, and so on. However, the configuration of the output data may be variously changed or modified, as necessary, and the present invention is not limited thereto.

In operation S205, a parallel transmission packet electrical signal may be generated. The optical connection protocol manager 530 may generate the parallel transmission packet electrical signal based on the output data. According to an example embodiment of the present invention, the electrical signal is transmitted and received in packet unit. The transmission packet buffer 532 may output a completed electrical signal when all bit strings for forming the electrical signal are stored. Herein, when buffer areas in the transmission packet buffer 532 are not fully in use, a bit string for forming an additional electrical signal may be further provided to the transmission packet buffer 532. The transmission packet generator 533 may generate the parallel transmission packet electrical signal by connecting a transmission header packet and data for error test. When a read operation is performed, the parallel transmission packet electrical signal may not include a transmission data packet.

In operation S210, the parallel transmission packet electrical signal may be serialized, and then a serialized transmission packet electrical signal may be generated. Furthermore, the serialized transmission packet electrical signal may be converted into a transmission packet optical signal. Herein, speed for serializing the parallel transmission packet electrical signal by the transmission packet serializer 534 needs to be designed to correspond to the bandwidth characteristic of the electro-optical converter 550. If speed for serializing the parallel transmission packet electrical signal by the transmission packet serializer 534 is relatively fast, a plurality of electro-optical converters 550 may be provided, as necessary. The transmission packet optical signal may be transmitted to the semiconductor memory module 400 (see the node F). The transmission packet optical signal may be a reception packet optical signal in view of the semiconductor memory module 400.

In operation S215, the reception packet optical signal may be converted into a serial reception packet electrical signal. Furthermore, the serial reception packet electrical signal may be parallelized by the reception packet parallelizer 335, and then a parallelized reception packet electrical signal may be generated.

In operation S220, whether there is an error in the parallelized reception packet electrical signal may be tested. The reception packet tester 336 may test whether there is an error in the parallelized reception packet electrical signal by using an error test algorithm. Whether there is an error may be tested based on the data for error test generated by the transmission packet generator 333.

In operation S225, whether there is an error may be determined. When there is an error, a re-transmission request may be generated in operation S230. As an example embodiment, according to a control of the reception packet tester 336, the semiconductor memory module 400 may transmit a signal, which corresponds to a command for receiving the parallelized reception packet electrical signal having no error, to the operation processing device 500. In this case, operation S205 may be performed again (see the node E). However, when there is no error, operation S235 may be performed.

In operation S235, the parallelized reception packet electrical signal may be parsed. Furthermore, data may be read in the semiconductor memory module 400 based on a parsing result. In particular, a read operation performed in the semiconductor memory module 400 may be performed based on information included in a reception header packet. Descriptions associated with the information included in the reception header packet have been mentioned with reference to FIGS. 3 and 5.

In operation S240, a parallel transmission packet electrical signal may be generated. The parallel transmission packet electrical signal generated in operation S240 may be a parallel electrical signal in packet unit to transmit output data read by a read operation from the semiconductor memory module 400 to the operation processing device 500. A process of generating the parallel transmission packet electrical signal in each of the N semiconductor memory chips 301, 302, and 303 in the semiconductor memory module 400 has been mentioned with reference to FIGS. 7 and 8.

In operation S245, the parallel transmission packet electrical signal may be serialized, and then a serialized transmission packet electrical signal may be generated. Furthermore, the serialized transmission packet electrical signal may be converted into a transmission packet optical signal. Herein, speed for serializing the parallel transmission packet electrical signal by the transmission packet serializer 334 needs to be designed to correspond to the bandwidth characteristic of the electro-optical converter 350. If speed for serializing the parallel transmission packet electrical signal by the transmission packet serializer 334 is relatively fast, a plurality of electro-optical converters 350 may be provided, as necessary. The transmission packet optical signal may be transmitted to the operation processing device 500 (see the node H). The transmission packet optical signal may be a reception packet optical signal in view of the operation processing device 500.

In operation S250, the reception packet optical signal may be converted into a serial reception packet electrical signal. Furthermore, the serial reception packet electrical signal may be parallelized, and then a parallelized reception packet electrical signal may be generated. In operation S255, whether there is an error in the parallelized reception packet electrical signal may be determined. The reception packet tester 536 may test whether there is an error in the parallelized reception packet electrical signal by using an error test algorithm. Whether there is an error may be tested based on the data for error test generated by the transmission packet generator 333. When there is an error, a re-transmission request may be generated in operation S260. In this case, operation S240 may be performed again (see the node G).

However, when there is no error, the reception packet buffer 537 may store a reception header packet and a reception data packet included in the parallelized reception packet electrical signal. The reception packet parser 538 may parse the reception header packet based on information included in the reception data packet. Descriptions associated with the information included in the reception header packet have been mentioned with reference to FIGS. 3 and 5. Input data generated based on a parsing result may be stored in the operation memory 510 of the operation processing device 500. As an example embodiment, even when there is no error in the parallelized reception packet electrical signal but redundant information is delivered, the input data may be erased. When there is no error, operation S235 may be performed continuously.

In operation S265, a parallel transmission packet electrical signal may be generated. The parallel transmission packet electrical signal generated in operation S265 may be a parallel electrical signal in packet unit to notify to the semiconductor memory module 400 that a read operation is performed successfully.

In operation S270, the parallel transmission packet electrical signal may be serialized, and then a serialized transmission packet electrical signal may be generated. Furthermore, the serialized transmission packet electrical signal may be converted into a transmission packet optical signal. The transmission packet optical signal may be transmitted to the semiconductor memory module 400 (see the node K). The transmission packet optical signal may be a reception packet optical signal in view of the semiconductor memory module 400.

In operation S275, the reception packet optical signal may be converted into a serial reception packet electrical signal. Furthermore, the serial reception packet electrical signal may be parallelized, and then a parallelized reception packet electrical signal may be generated. In operation S280, whether there is an error in the parallelized reception packet electrical signal may be determined. When there is an error, a re-transmission request may be generated in operation S285. In this case, operation S265 may be performed again (see the node J). However, when there is no error, operation S90 may be performed.

As an example embodiment, the semiconductor memory module 400 or the operation processing device 500 may stand by until the parallelized reception packet electrical signal having no error is provided. Furthermore, when a standing-by time of the semiconductor memory module 400 or the operation processing device 500 exceeds a critical value, the semiconductor memory module 400 or the operation processing device 500 may determine that there is an error in the re-transmission request and generate the re-transmission request again.

In operation S290, it may be confirmed that a read operation is performed successfully. The semiconductor memory module 400 may confirm the completion of the read operation, and then may prepare the next write or read operation. Once the read operation is completed, the process illustrated in FIGS. 12A and 12B may be terminated. However, when another read operation command is generated, the process illustrated in FIGS. 12A and 12B may be performed repeatedly. Alternatively, when another write operation command is generated, the process illustrated in FIGS. 11A and 11B may be performed repeatedly.

In the above descriptions, as a device including an interface circuit according to an example embodiment of the present invention, the semiconductor memory chip 300 (see FIG. 7) and the operation processing device 500 (see FIG. 9) are disclosed. However, the interface circuit according to an example embodiment of the present invention may be included in any other kinds of electronic devices, which are capable of transmitting/receiving signals to/from another electronic device. Any electronic device including the interface circuit according to an example embodiment of the present invention may obtain the above-mentioned effects.

According to example embodiments of the present invention, the line width of a transmission line may be reduced. Accordingly, the complexity of a layout on a board may be reduced. Furthermore, the complexity of a physical device configuration for signal control may be reduced. In particular, when an interface circuit according to an example embodiment of the present invention is included in a semiconductor memory chip and/or an operation processing device, since a signal control in packet unit may be possible instead of a signal control based on a clock signal, a device initialization process may be omitted. Furthermore, since the line width of a transmission line is reduced and a device configuration becomes simpler, an operation processing device may be connected to much more semiconductor memory chips. As a result, a computing system having high processing performance may be obtained.

A configuration illustrated in each conceptual diagram should be understood just from a conceptual point of view. Shape, structure, and size of each component illustrated in each conceptual diagram are exaggerated or downsized for understanding of the present invention. An actually implemented configuration may have a physical shape different from a configuration of each conceptual diagram. The present invention is not limited to a physical shape or size illustrated in each conceptual diagram.

A device configuration illustrated in each block diagram is used to help understanding of the present invention. Each block may be formed of smaller blocks according to a function. Alternatively, a plurality of blocks may form a larger block according to a function. That is, the present invention is not limited to the configurations illustrated in the block diagrams.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. An interface circuit configured to transmit and receive signals between electronic devices, the interface circuit comprising:
an optical connection protocol manager configured to:
serialize a parallel transmission packet electrical signal generated based on output data, to generate a serialized transmission packet electrical signal,
parallelize a serial reception packet electrical signal to generate a parallelized reception packet electrical signal, and
parse the parallelized reception packet electrical signal according to whether there is an error in the parallelized reception packet electrical signal, to generate input data; and
an electro-optical converter configured to:
convert the serialized transmission packet electrical signal into a transmission packet optical signal, to output the transmission packet optical signal,
receive a reception packet optical signal, and
convert the reception packet optical signal into the serial reception packet electrical signal, to provide the serial reception packet electrical signal to the optical connection protocol manager.

2. The interface circuit of claim 1, wherein the optical connection protocol manager comprises:
a transmission packet buffer configured to:
store a transmission header bit string and a transmission data bit string based on the output data, the transmission header bit string being to be included in a transmission header packet, the transmission data bit string being included in a transmission data packet,
output the transmission header packet when all transmission header bit strings to be included in the transmission header packet are stored, and
output the transmission data packet when all transmission data bit strings to be included in the transmission data packet are stored;
a transmission packet generator configured to:
generate data for error test based on the transmission header packet and the transmission data packet, and
generate the parallel transmission packet electrical signal by connecting the transmission header packet, the transmission data packet, and the data for error test; and
a transmission packet serializer configured to:
serialize the parallel transmission packet electrical signal to generate the serialized transmission packet electrical signal, and
provide the serialized transmission packet electrical signal to the electro-optical converter.

3. The interface circuit of claim 2, wherein the transmission header packet comprises information associated with at least one of a length of a packet bit string and a parsing order of each of a plurality of transmission packets, the parsing order being an order for parsing when the output data is converted into the plurality of transmission packets.

4. The interface circuit of claim 2, wherein the optical connection protocol manager further comprises a bit string generator configured to generate the transmission header bit string and the transmission data bit string based on the output data.

5. The interface circuit of claim 2, wherein the optical connection protocol manager further comprises:
a reception packet parallelizer configured to parallelize the serial reception packet electrical signal to generate the parallelized reception packet electrical signal;
a reception packet tester configured to test whether there is an error in the parallelized reception packet electrical signal; and
a reception packet parser configured to parse a reception header packet and a reception data packet to generate the input data when there is no error in the parallelized reception packet electrical signal, the reception header packet and the reception data packet being included in the parallelized reception packet electrical signal.

6. The interface circuit of claim 5, wherein the optical connection protocol manager further comprises a reception packet buffer configured to store the reception header packet and the reception data packet when there is no error in the parallelized reception packet electrical signal.

7. The interface circuit of claim 5, wherein when there is an error in the parallelized reception packet electrical signal, the transmission packet optical signal corresponding to a command for receiving the parallelized reception packet electrical signal having no error is output, according to a control of the reception packet tester.

8. The interface circuit of claim 5, wherein the reception header packet comprises information associated with at least one of a length of a packet bit string and a parsing order of each of a plurality of reception packets, the parsing order being an order for parsing when the input data is parsed from the plurality of reception packets.

9. A semiconductor memory chip comprising:
a memory cell array configured to store data;
an optical connection protocol manager configured to:
serialize a parallel transmission packet electrical signal generated based on output data, to generate a serialized transmission packet electrical signal, the output data being to be output from the memory cell array,
parallelize a serial reception packet electrical signal to generate a parallelized reception packet electrical signal, and
parse the parallelized reception packet electrical signal according to whether there is an error in the parallelized reception packet electrical signal, to generate input data to be stored in the memory cell array;
an electro-optical converter configured to:
convert the serialized transmission packet electrical signal into a transmission packet optical signal, to output the transmission packet optical signal,
receive a reception packet optical signal, and
convert the reception packet optical signal into the serial reception packet electrical signal, to provide the serial reception packet electrical signal to the optical connection protocol manager; and
a memory controller configured to control the memory cell array and the optical connection protocol manager in order to output the output data and store the input data.

10. The semiconductor memory chip of claim 9, wherein the optical connection protocol manager comprises:
a transmission packet buffer configured to:
store a transmission header bit string and a transmission data bit string based on the output data, the transmission header bit string being to be included in a transmission header packet, the transmission data bit string being included in a transmission data packet,
output the transmission header packet when all transmission header bit strings to be included in the transmission header packet are stored, and
output the transmission data packet when all transmission data bit strings to be included in the transmission data packet are stored;
a transmission packet generator configured to:
generate data for error test, based on the transmission header packet and the transmission data packet, and
generate the parallel transmission packet electrical signal by connecting the transmission header packet, the transmission data packet, and the data for error test; and
a transmission packet serializer configured to:
serialize the parallel transmission packet electrical signal to generate the serialized transmission packet electrical signal, and
provide the serialized transmission packet electrical signal to the electro-optical converter.

11. The semiconductor memory chip of claim 10, wherein the optical connection protocol manager further comprises:
a reception packet parallelizer configured to parallelize the serial reception packet electrical signal to generate the parallelized reception packet electrical signal;
a reception packet tester configured to test whether there is an error in the parallelized reception packet electrical signal; and
a reception packet parser configured to parse a reception header packet and a reception data packet to generate the input data when there is no error in the parallelized reception packet electrical signal, the reception header packet and the reception data packet being included in the parallelized reception packet electrical signal.

12. The semiconductor memory chip of claim 11, wherein the reception header packet comprises information associated with at least one of a length of a packet bit string, a parsing order of each of a plurality of transmission packets, a type of an operation to be performed, and an address of a storage area in the memory cell array where the operation is to be performed, the parsing order being an order for parsing when the input data is parsed from the plurality of reception packets.

13. An operation processing device comprising:
an operation memory configured to store data used to perform an operation;
an optical connection protocol manager configured to:
serialize a parallel transmission packet electrical signal generated based on output data, to generate a serialized transmission packet electrical signal, the output data being to be output from the operation memory,
parallelize a serial reception packet electrical signal to generate a parallelized reception packet electrical signal, and
parse the parallelized reception packet electrical signal according to whether there is an error in the parallelized reception packet electrical signal, to generate input data to be stored in the operation memory; and
an electro-optical converter configured to:
convert the serialized transmission packet electrical signal into a transmission packet optical signal, to output the transmission packet optical signal,
receive a reception packet optical signal, and
convert the reception packet optical signal into the serial reception packet electrical signal, to provide the serial reception packet electrical signal to the optical connection protocol manager.

14. The operation processing device of claim 13, wherein the optical connection protocol manager comprises:
a bit string generator configured to generate a transmission header bit string and a transmission data bit string based on the output data, the transmission header bit string being to be included in a transmission header packet, the transmission data bit string being included in a transmission data packet;
a transmission packet buffer configured to:
store the transmission header bit string and the transmission data bit string,
output the transmission header packet when all transmission header bit strings to be included in the transmission header packet are stored, and
output the transmission data packet when all transmission data bit strings to be included in the transmission data packet are stored;
a transmission packet generator configured to:
generate data for error test, based on the transmission header packet and the transmission data packet, and
generate the parallel transmission packet electrical signal by connecting the transmission header packet, the transmission data packet, and the data for error test; and
a transmission packet serializer configured to:
serialize the parallel transmission packet electrical signal to generate the serialized transmission packet electrical signal, and
provide the serialized transmission packet electrical signal to the electro-optical converter.

15. The operation processing device of claim 14, wherein the optical connection protocol manager further comprises:
a reception packet parallelizer configured to parallelize the serial reception packet electrical signal to generate the parallelized reception packet electrical signal;
a reception packet tester configured to test whether there is an error in the parallelized reception packet electrical signal;
a reception packet buffer configured to store a reception header packet and a reception data packet when there is no error in the parallelized reception packet electrical signal, the reception header packet and the reception data packet being included in the parallelized reception packet electrical signal; and
a reception packet parser configured to parse the reception header packet and the reception data packet to generate the input data.

16. The operation processing device of claim 15, wherein whether buffer areas in at least one of the transmission packet buffer and the reception packet buffer are fully used is monitored, and
wherein when the buffer areas are not fully used, the bit string generator is further configured to transmit a control signal for requesting new output data to the operation memory.
